(19) United States
(12) Patent Application Publication
(10) Pub. No.: US 2018/0043866 A1
(43) Pub. Date: Feb. 15, 2018

(54) BRAKE EMULATOR OF A BRAKE-BY-WIRE SYSTEM

(71) Applicant: GM GLOBAL TECHNOLOGY OPERATIONS LLC, Detroit, MI (US)

(72) Inventors: Patrick J. Monsere, Highland, MI (US); Brandon C. Pennala, Howell, MI (US); Christopher C. Chappell, Commerce Township, MI (US); Paul A. Kilmurray, Wixom, MI (US)

(21) Appl. No.: 15/234,435

(22) Filed: Aug. 11, 2016

(51) Int. Cl. B60T 7/06; B60T 7/04

(52) U.S. Cl. CPC B60T 7/06; B60T 7/042; B60T 2270/82

(57) ABSTRACT

A brake pedal assembly of a brake emulator includes a resiliently flexible arm constructed and arranged to include a flexibility that mimics, at least in-part, a pre-determined braking force profile. The flexible arm includes opposite first and second end portions and a pivot point disposed there-between.

### FIELD OF THE INVENTION

The subject invention relates to a brake-by-wire (BBW) system, and more particularly, to a brake emulator of the BBW system.

### BACKGROUND

Traditional service braking systems of a vehicle are typically hydraulic fluid based systems actuated by a driver depressing a brake pedal that generally actuates a master cylinder. In-turn, the master cylinder pressurizes hydraulic fluid in a series of hydraulic fluid lines routed to respective actuators at brakes located adjacent to each wheel of the vehicle. Such hydraulic braking may be supplemented by a hydraulic modulator assembly that facilitates anti-lock braking, traction control, and vehicle stability augmentation features. The wheel brakes may be primarily operated by the manually actuated master cylinder with supplemental actuation pressure gradients supplied by the hydraulic modulator assembly during anti-lock, traction control, and stability enhancement modes of operation.

When a plunger of the master cylinder is depressed by the brake pedal to actuate the wheel brakes, pedal resistance is encountered by the driver. This resistance may be due to a combination of actual braking forces at the wheels, hydraulic fluid pressure, mechanical resistance within the booster/master cylinder, the force of a return spring acting on the brake pedal, and other factors. Consequently, a driver is accustomed to and expects to feel this resistance as a normal occurrence during operation of the vehicle. Unfortunately, the ‘feel’ of conventional brake pedals is not adjustable to meet the desires of a driver.

More recent advancements in braking systems include BBW systems that actuate the vehicle brakes via an electric signal typically generated by an on-board controller. Brake torque may be applied to the wheel brakes without a direct hydraulic link to the brake pedal. The BBW system may be an add-on, (i.e., and/or replace a portion of the more conventional hydraulic brake systems), or may completely replace the hydraulic brake system (i.e., a pure BBW system). In either type of BBW system, the brake pedal ‘feel’, which a driver is accustomed to, must be emulated.

Accordingly, it is desirable to provide a brake emulator that may simulate the brake pedal ‘feel’ of more conventional brake systems, and may be fault tolerant.

### SUMMARY OF THE INVENTION

In one exemplary embodiment of the invention, a brake pedal assembly of a brake emulator includes a resiliently flexible arm constructed and arranged to include a flexibility that mimics at least in-part a pre-determined braking force profile. The flexible arm includes opposite first and second end portions and a pivot point disposed there-between.

In another exemplary embodiment of the invention, a vehicle brake emulator is actuated by a driver and includes a fixed structure and a resiliently flexible arm. The arm is connected to the fixed structure at a pivot axis, and includes a end portion constructed and arranged to receive an applied braking pressure by the driver.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic of a vehicle having a BBW system as one non-limiting example in accordance with the present disclosure;

FIG. 2 is a schematic of the BBW system including a brake emulator;

FIG. 3 is a perspective view of a brake pedal assembly of the brake emulator;

FIG. 4 is a side view of the brake emulator illustrated in flexed and un-flexed states; and

FIG. 5 is a graph of a braking force profile of the brake emulator.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the terms module and controller refer to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

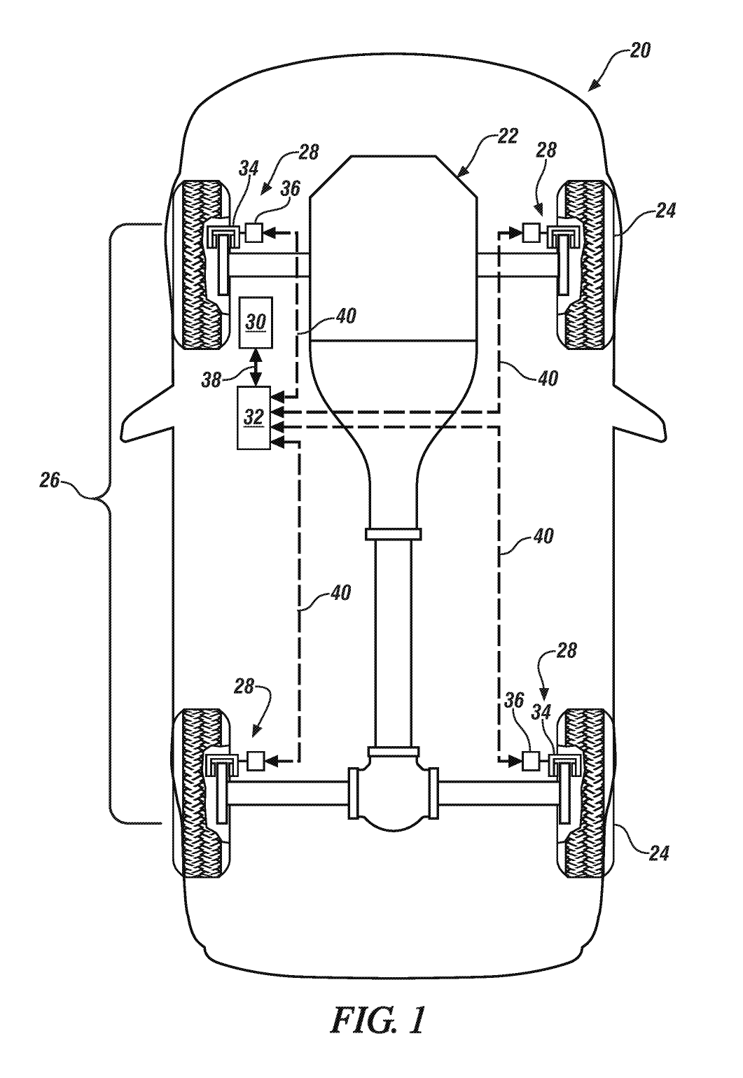

In accordance with an exemplary embodiment of the invention, FIG. 1 is a schematic of a vehicle 20 that may include a powertrain 22 (i.e., an engine, transmission and differential), a plurality of rotating wheels 24 (i.e., four illustrated), and a BBW system 26 that may include a brake assembly 28 for each respective wheel 24, a brake emulator 30, and a controller 32. The powertrain 22 is adapted to drive at least one of the wheels 24 thereby propelling the vehicle 20 upon a surface (e.g., road). The BBW system 26 is configured to generally slow the speed and/or stop motion of the vehicle 20. The vehicle 20 may be an automobile, truck, van, sport utility vehicle, or any other self-propelled or towed conveyance suitable for transporting a burden.

Each brake assembly 28 of the BBW system 26 may include a brake 34 and an actuator 36 configured to operate the brake. The brake 34 may include a caliper and may be any type of brake including disc brakes, drum brakes, and others. As non-limiting examples, the actuator 36 may be an electro-hydraulic brake actuator (EHBA) or other actuator capable of actuating the brake 34 based on an electrical input signal that may be received from the controller 32. More specifically, the actuator 36 may be or include any type of motor capable of acting upon a received electric signal and as a consequence converting energy into motion that controls movement of the brake 34. Thus, the actuator 36 may be a direct current motor configured to generate electro-hydraulic pressure delivered to, for example, the calipers of the brake 34.

The controller 32 may include a computer-based processor (e.g., microprocessor) and a computer readable and writeable storage medium. In operation, the controller 32 may receive one or more electrical signals from the brake emulator 30 over a pathway (see arrow 38) indicative of driver braking intent. In-turn, the controller 32 may process such signals, and based at least in-part on those signals, output an electrical command signal to the actuators 36 over a pathway (see arrow 40). Based on any variety of vehicle conditions, the command signals directed to each wheel 24 may be the same or may be distinct signals for each wheel 24. The pathways 38, 40 may be wired pathways, wireless pathways, or a combination of both. Non-limiting examples of the controller 32 may include an arithmetic logic unit that performs arithmetic and logical operations; an electronic control unit that extracts, decodes, and executes instructions from a memory; and, an array unit that utilizes multiple parallel computing elements. Other examples of the controller 32 may include an engine control module, and an application specific integrated circuit. It is further contemplated and understood that the controller 32 may include redundant controllers, and/or the system may include other redundancies, to improve reliability of the BBW system 26.

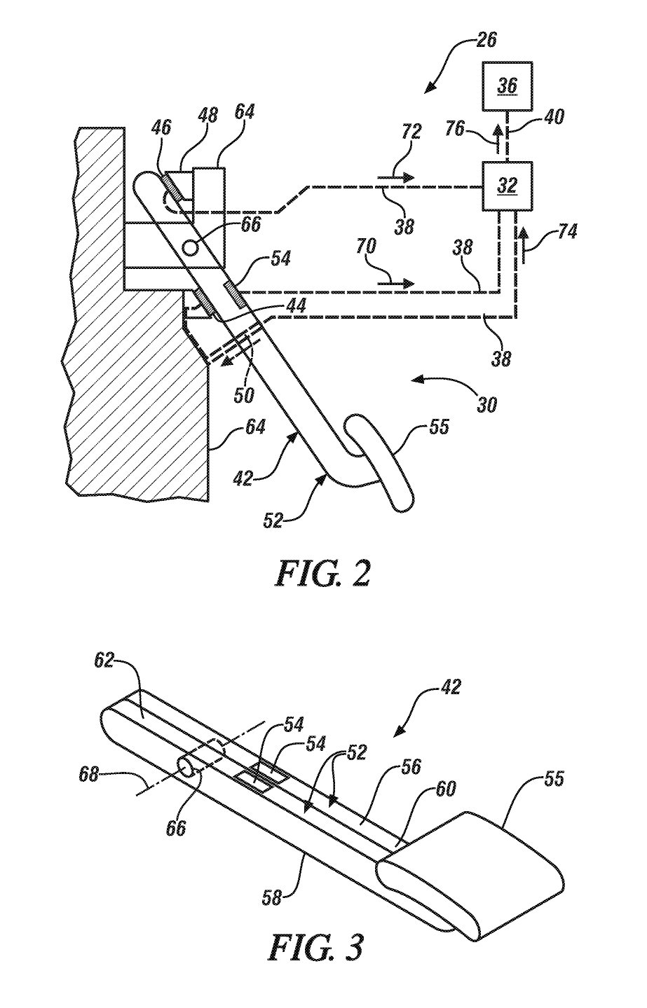

Referring to FIGS. 2 and 3, the brake emulator 30 may include a brake pedal assembly 42, a first contact stop 44, a second contact stop 46, a force sensor 48, and a displacement sensor 50. The brake pedal assembly 42 may include a multitude of arms 52 (i.e., two illustrated in FIG. 3), a strain-based sensor 54 (e.g., strain gage) integrated into each arm 52, and a brake pad 55. Each arm 52 may be elongated, resiliently flexible, and aligned side-by-side to one another. The introduction of multiple arms 52, as opposed to one, introduces a degree of fault tolerance. For example, if one arm is fatigued or should otherwise fail, the remaining arms 52 will suffice to achieve the braking action of the vehicle 20.

Each arm 52 may include a front side 56, an opposite back side 58, a first end portion 60, and an opposite second end portion 62. Each arm 52 may be pivotally engaged to a support structure 64 that may be fixed (see FIG. 2) at a pivot point 66 and aligned along a common pivot axis 68. The pivot points 66 may be spaced between the end portions 60, 62 of the respective arms 52. The arm 52 may be made of any material that can withstand cyclic stresses, and may include plastic, spring steel, and others. It is contemplated and understood that linear damping may be designed into the flexible arm 52 by fabricating the arm with multiple laminations such that relative motion between the laminations may create a damping force during deflection of the arm 52.

The brake pad 55 of the brake pedal assembly 42 may be a brake foot pad and, in one example, may directly receive a pressure applied by the foot of a driver desiring to slow or stop the vehicle 20. The first end portions 60 of each arm 52 may be engaged to the brake pad 55. The brake pad 55 may further be engaged to or otherwise positioned against the front side 56 of each arm 52. Other than the engagement of the brake pad 55 to the arms 52, the arms may not otherwise be engaged and/or adhered to one-another, thereby providing a degree of independent operation should one arm fail.

The strain-based sensor or strain gage 54 of the brake pedal assembly 42 may be one type of sensor used to measure a strain or force associated with a pressure applied by the driver upon the brake pad 55. Each strain gage 54 of each arm 52 may be located between the respective pivot points 66 and end portion 60 of each arm 52, and may further be proximate to the front sides 56. In operation, the strain gage 54 is configured to send a signal (see arrow 70 in FIG. 2) over pathway 38 to the controller 32 for processing.

For explanation simplicity, one arm 52 will be further described, but it is understood that all of the arms may individually include respective interfacing components adding a degree of redundancy and fault tolerance into the BBW system 26. The first contact stop 44 may generally be carried between the fixed structure 64 and the back side 58 of the arm 52, and may be spaced between the pivot point 66 and the first end portion 60. The second contact stop 46 may generally be carried between the fixed structure 64 and the front side 56 of the arm 52, and may be proximate to the second end portion 62. One or both stops 44, 46 may generally be, for example, a pad that may be resiliently pliable and adhered, or otherwise engaged, to either of the structure 64 or the arm 52. The stops 44, 46 may be sufficiently soft to enable a degree of travel of the arm 52 (i.e., pivotal motion) generally before the arm begins flexing. One, non-limiting example of a stop material may be EPDM rubber.

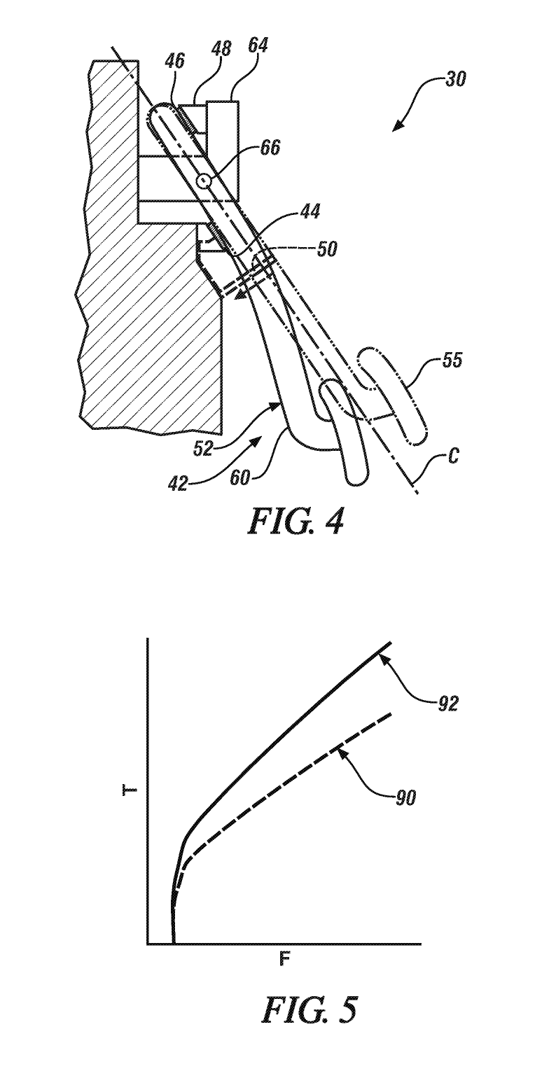

Referring to FIG. 4, when the arm 52 is not flexed, the arm extends along a centerline C that may or may not be linear (i.e., shown to be substantially linear in the present example). When flexed, the two portions of the arm 52 may resiliently bend with each portion generally becoming offset from the centerline C. The first portion may generally be located between the contact stop 44 and the first end portion 60, and the second portion 62 may be substantially located between the pivot point 66 and the contact stop 46. It is further contemplated and understood that the structural rigidity of the arm 52 may be designed such that one of the two portions may not flex, or one of the two portions is designed to flex more than the other portion.

Referring to FIGS. 2 and 4, the force sensor 48 of the brake emulator 30 detects and measures a force associated with the pressure applied at the brake pad 55 by the driver. The force sensor 48 may be the strain gage 54, may be in addition to the strain gage, or may generally be in place of the strain gage. If the force sensor 48 is not the strain gage previously described, the sensor 48 may generally be located at the second stop 46. In operation, the force sensor 48 is configured to send a signal (see arrow 72 in FIG. 2) over pathway 38 to the controller 32 for processing. It is contemplated and understood that the force sensor 48 may be located at the contact stop 44, or other locations sufficient to measure a parameter associated with a pressure applied at the brake pad 55. It is further understood that the emulator 30 may include more than one force sensor 48 (i.e., pressure) configured to, for example, output redundant signals to more than one controller to facilitate fault tolerance for sensor faults.

The travel sensor 50 of the brake emulator 30 detects and measures a displacement between the fixed structure 64 and the arm 52 of the brake pedal assembly 42. The travel sensor 50 may be engaged to, and carried by, the arm 52 or the fixed structure 64, and may be generally located between the strain gage 54 and the first end portion 60 of the arm 52. The travel sensor 50 may be any number of types including ultrasonic, optical, and magnetic sensors. The actual location of the sensor 50 may be partially dependent upon packaging of the brake emulator 30 and/or partially dependent upon accuracy requirements (i.e., greater the displacement the greater the accuracy). In operation, the travel sensor 50 is configured to send a signal (see arrow 74 in FIG. 2) over pathway 38 to the controller 32 for processing. To optimize system reliability and/or reduce systematic system failure, the brake emulator 30 may include more than one displacement sensor 50 placed at different locations.

The brake emulator 30 may be a ‘passive’ emulator in the sense that the emulator 30 may not be directly or actively controlled by the controller 32, yet is configured to simulate the behavior and/or ‘feel’ of a more traditional hydraulic braking system (e.g., vacuum-boosted pedal characteristics). In operation, as a driver applies an initial pressure to the brake pad 55, the arm 52 may begin to displace by pivoting about pivot point 66. During this displacement, the contact stops 44, 46 may compress between the arm 52 and the fixed structure 64. Also during this displacement, the travel sensor 50 sends the signal 74 indicative of the arm displacement to the controller 32, and one or both of the force sensor 48 and the strain gage 54 sends respective signals 72, 70 indicative of the pressure or force applied to the brake pad 55 to the controller 32. The controller 32 processes the signals 70, 72, 74 and sends an appropriate command signal (see arrow 76 in FIG. 2) to the brake actuators 36 over pathway 40.

Referring to FIG. 4, with an increase in pressure or force applied to the brake pad 55 by the driver, the contact stops 44, 46 may be substantially fully compressed and the arm 52 may begin to flex. During this additional displacement (i.e., measured from a reference point spaced from the pivot point 66 and at or toward the first end portion 60), the travel sensor 50 sends the signal 74 indicative of the additional arm displacement to the controller 32, and one or both of the force sensor 48 and the strain gage 54 sends respective signals 72, 70 indicative of the additional pressure or force applied to the brake pad 55 to the controller 32. The controller 32 processes the signals 70, 72, 74 and sends an appropriate command signal (see arrow 76 in FIG. 2) to the brake actuators 36 over pathway 40 to increase brake actuation/pressure.

Referring to FIG. 5, a braking force profile graph of pedal travel T (i.e., arm 52 displacement) versus applied pedal force F (i.e., pressure) is illustrated. The profile or curve 90 reflects normal operation of the brake pedal assembly 42 where the resilient pliability of the contact stops 44, 46 and the resilient flexibility of the arm 52 is pre-determined by design to achieve profile 90. As previously described, the brake pedal assembly 42 may include multiple arms 52. In a scenario where, for example, one of the arms 52 becomes damaged, the braking force profile may resemble curve 92 where it requires less force to achieve greater pedal travel. The controller 32 may be programmed to detect such a change in the braking force profile, and thus take appropriate action.

Advantages and benefits of the present disclosure include a low-cost, passive, brake emulator 30 capable of mimicking the feel of a more traditional brake system such as a vacuum boosted system without the use of an external spring. Because braking stiffness or feel characteristics are integrated physically into the brake arm(s) 52 and brake stops 44, 46, the brake emulator 30 does not require additional hardware. Yet further, the brake emulator 30 includes certain redundancies to limit or prevent failure.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A brake pedal assembly comprising:
a first resiliently flexible arm including a back side, a front side, a first end portion, an opposite second end portion, and a first pivot point disposed between the first and second end portion, and wherein the flexibility of the resiliently flexible arm at least in-part mimics a pre-determined braking force profile.

2. The brake pedal assembly set forth in claim 1 further comprising:
a second resiliently flexible arm arranged side-by-side to the first resiliently flexible arm, the second resiliently flexible arm including a front side, a first end portion, an opposite second end portion, and a second pivot point aligned to the first pivot point; and
a brake pad engaged to the first end portions.

3. The brake pedal assembly set forth in claim 1, wherein the first resiliently flexible arm includes a first contact carried by the front side and proximate to the second end portion, and a second contact carried by the back side and disposed between the first pivot point and the first end portion.

4. The brake pedal assembly set forth in claim 3 further comprising:
a strain-based sensor integrated into the first resiliently flexible arm.

5. The brake pedal assembly set forth in claim 4, wherein the strain-based sensor is disposed between the first pivot point and the first end portion.

6. The brake pedal assembly set forth in claim 5, wherein the strain-based sensor is proximate to the front side.

7. A vehicle brake emulator actuated by a driver, the vehicle brake emulator comprising:
a fixed structure; and
a first resiliently flexible arm connected to the fixed structure at a pivot axis, the first resiliently flexible arm including a first end portion constructed and arranged to receive an applied braking pressure by the driver.

8. The vehicle brake emulator set forth in claim 7 further comprising:
a first contact stop carried between the fixed structure and a front side of the first resiliently flexible arm proximate to a second end portion that is opposite the first end portion, and wherein the pivot axis is spaced between the first and second end portions.

9. The vehicle brake emulator set forth in claim 8, wherein the first contact stop is resiliently pliable for compression when the vehicle brake emulator is actuated.

10. The vehicle brake emulator set forth in claim 9, wherein the first contact stop is constructed and arranged to compress before the first resiliently flexible arm flexes when the braking pressure is applied.

11. The vehicle brake emulator set forth in claim 8 further comprising:
a second contact stop carried between the fixed structure and a back side of the first resiliently flexible arm and spaced between the pivot axis and the first end portion.

12. The vehicle brake emulator set forth in claim 11, wherein the second contact stop is resiliently pliable for compression when the vehicle brake emulator is actuated.

13. The vehicle brake emulator set forth in claim 12, wherein the second contact stop is constructed and arranged to compress before the first resiliently flexible arm flexes when the braking pressure is applied.

14. The vehicle brake emulator set forth in claim 10 further comprising:
a resiliently pliable second contact stop carried between the fixed structure and a back side of the first resiliently flexible arm and spaced between the pivot axis and the first end portion, and wherein the second contact stop is constructed and arranged to compress before the first resiliently flexible arm flexes when the braking pressure is applied.

15. The vehicle brake emulator set forth in claim 7 further comprising:
a first contact stop carried between the fixed structure and a front side of the first resiliently flexible arm proximate to a second end portion that is opposite the first end portion, and wherein the pivot axis is spaced between the first and second end portions;
a second contact stop carried between the fixed structure and a back side of the first resiliently flexible arm and spaced between the pivot axis and the first end portion; and
a force sensor proximate to at least one of the first and second contact stops.

16. The vehicle brake emulator set forth in claim 15 further comprising:
a strain gage supported by the first resiliently flexible arm and configured to measure strain of the first resiliently flexible arm.

17. The vehicle brake emulator set forth in claim 16, wherein the strain gage is generally disposed between the pivot axis and the first end portion.

18. The vehicle brake emulator set forth in claim 15 further comprising:
a travel sensor carried between the fixed structure and the first resiliently flexible arm, and configured to measure displacement between the fixed structure and the first resiliently flexible arm.

19. The vehicle brake emulator set forth in claim 18, wherein the travel sensor is generally disposed between the second contact stop and the first end portion.

20. The vehicle brake emulator set forth in claim 7 further comprising:
a second resiliently flexible arm arranged side-by-side to the first resiliently flexible arm and connected to the fixed structure at the pivot axis, the second resiliently flexible arm including a first end portion constructed and arranged to receive the applied braking pressure by the driver.
